(19) United States
(12) Patent Application Publication
(10) Pub. No.: US 2026/0310440 A1
(43) Pub. Date: Oct. 8, 2026

(54) SYSTEMS AND METHODS FOR ENABLING PRIORITIZATION OF VEHICLE FEATURE SUBSCRIPTION SHARING

(71) Applicant: Ford Global Technologies, LLC, Dearborn, MI (US)

(72) Inventors: Brendan Diamond, Naples, FL (US); Thomas Joseph Hermann, Troy, MI (US); Keith Weston, Canton, MI (US)

(73) Assignee: Ford Global Technologies, LLC, Dearborn, MI (US)

(21) Appl. No.: 19/169,599

(22) Filed: Apr. 3, 2025

(51) Int. Cl. G06F 8/65; B60W 50/08

(52) U.S. Cl. CPC G06F 8/65; B60W 50/08; B60W 2556/45

(57) ABSTRACT

A subscription management system including a transceiver and a processor is disclosed. The transceiver may receive a first request from a first user associated with a first vehicle to enable a subscription based vehicle feature in the first vehicle, and a second request from a second user associated with a second vehicle to enable the subscription based vehicle feature in the second vehicle. The processor may obtain first information associated with the first user and the first vehicle, and second information associated with the second user and the second vehicle, responsive to obtaining the first request and the second request. The processor may further determine a priority of vehicle feature usage between the first user and the second user based on the first information and the second information, and enable the subscription based vehicle feature in either the first vehicle or the second vehicle based on the priority.

### FIELD

The present disclosure relates to vehicles and more specifically to systems and methods for enabling prioritization of vehicle feature subscription sharing.

### BACKGROUND

Modern vehicles provide a plurality of features to enhance a user's driving and vehicle usage experience. Examples of such features include Advanced Driver Assistance System (ADAS), navigation assistance system, vehicle-to-vehicle (V2V) communication, airbags, and/or the like. There are additional “premium” features that the users can purchase from the vehicle manufacturer or dealer on subscription. Such premium features are typically made accessible in the vehicle after the user purchases the subscription.

As an example, the user may purchase a subscription for an autonomous driving feature or remote parking assist feature for a predefined time duration (e.g., 1 year, 3 years, 7 years, etc.). In this case, the vehicle may enable the user to use the autonomous driving feature or the remote parking assist feature for the predefined time duration after the user purchases the subscription.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a view of two users requesting access to a subscription based vehicle feature from a subscription management system in accordance with the present disclosure.

FIG. 3 depicts example parameters used by a subscription management system to determine a priority of vehicle feature usage in accordance with the present disclosure.

FIG. 4 depicts a flow diagram of an example method to enable prioritization of vehicle feature subscription sharing in accordance with the present disclosure.

### DETAILED DESCRIPTION

### Overview

The present disclosure describes a system and method that enables prioritization of subscription sharing of premium vehicle features amongst a plurality of users/drivers and vehicles. The system ensures that “high priority” drivers are given access to the subscription based premium vehicle features, and the subscriptions are optimally distributed amongst the drivers. In an exemplary aspect, the system may enable a fleet manager to optimally distribute the subscriptions of premium vehicle features owned by the fleet manager amongst the drivers/operators/users of a vehicle fleet. In another exemplary aspect, the system may enable a vehicle owner (or a subscription owner) to optimally distribute the subscriptions of premium vehicle features owned by the vehicle owner amongst the owner's friends and family members. The description below describes an aspect where the system distributes the subscriptions amongst the drivers/users of a vehicle fleet; however, such description should not be construed as limiting the applicability of the present disclosure to only vehicle fleets.

In some aspects, to enable efficient subscription distribution amongst the drivers, the fleet manager may define or communicate to the system which subscriptions can be made shareable with which drivers/vehicles, if the fleet manger has purchased subscriptions for multiple premium vehicle features. The fleet manager may further define or communicate to the system the count of “subscribed accounts” (or subscribed users or logins) that the fleet manager purchased. The fleet manager may further define a subscription policy (or a “multi-token subscription policy”) indicating a preferred manner in which the fleet manager may desire the subscription logins to be distributed amongst the drivers.

Responsive to receiving the information described above from the fleet manager, the system may first create a “sharing network” including the drivers of the fleet vehicles who may request for the subscription based premium vehicle feature. The system may further generate a plurality of tokens associated with the subscription based vehicle feature based on the subscription policy defined by the fleet manager. A token associated with a subscription based vehicle feature may be an authentication or authorization means by which a vehicle may enable the vehicle feature in the vehicle. To enable a premium feature in a vehicle, the driver/operator associated with the vehicle may transmit a request to the system to obtain the corresponding token.

Responsive to generating the plurality of tokens associated with the subscription-based vehicle feature based on the subscription policy, the system may make the tokens “available” in the sharing network including the drivers of the fleet vehicles. If the count of tokens that are generated and made available in the sharing network is less than the count of subscription logins/accounts owned by the fleet manager, the drivers may use the token without any conflict. However, a conflict may occur if the count of tokens that are generated and made available in the sharing network is greater than the count of subscription logins/accounts owned by the fleet manager. In this case, the system may determine a priority list of the drivers requesting to obtain the tokens and may distribute the tokens (and hence make the premium feature enabled in the driver's vehicles) as per the priority list. The system may determine the priority of premium vehicle feature usage amongst the drivers based on a plurality of different parameters, as briefly described below.

In one exemplary aspect, the system may determine the priority of vehicle feature usage between the drivers based on a usage hierarchy defined by the fleet manager. In another exemplary aspect, the system may determine the priority of vehicle feature usage between the drivers based on the historical usage of the subscription based premium vehicle feature by each driver. In yet another exemplary aspect, the system may determine the priority of vehicle feature usage between the drivers based on a maximum permissible time (e.g., 2 hours or 3 hours) of vehicle feature usage in a predefined time duration (e.g., over a day), as defined by the fleet manager. In yet another exemplary aspect, the system may determine the priority of vehicle feature usage between the drivers based on the operational conditions of the vehicles associated with the drivers (e.g., if any vehicle is connected to a trailer, the driver of that vehicle is given a higher priority). In yet another exemplary aspect, the system may determine the priority of vehicle feature usage between the drivers based on the driving experiences, employment experiences, the total driving time in a day, and/or the like, associated with the drivers.

Responsive to determining the priority of vehicle feature usage between the drivers by using any of the parameters described above, the system may enable the subscription based premium vehicle feature in the vehicle(s) associated with the driver(s) having the higher priorities. In some aspects, the system may enable the premium vehicle feature in a vehicle by transmitting a token (from the plurality of tokens generated by the system) associated with the vehicle feature to the vehicle.

In this manner, the system ensures that “high priority” drivers use the subscription based premium vehicle features, and the subscribed vehicle features are not unnecessarily used for a long time duration by those users who may be lower in the priority list.

The present disclosure discloses a system and method that enables a subscription owner to optimally distribute subscription based premium vehicle features amongst a plurality of drivers/operators. The system ensures that the subscription distribution is as per the subscription owner's preferences or the subscription policy defined by the owner. The system further enables multiple vehicles to access subscription based premium vehicle features concurrently (provided the subscription owner has purchased multiple logins/accounts).

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

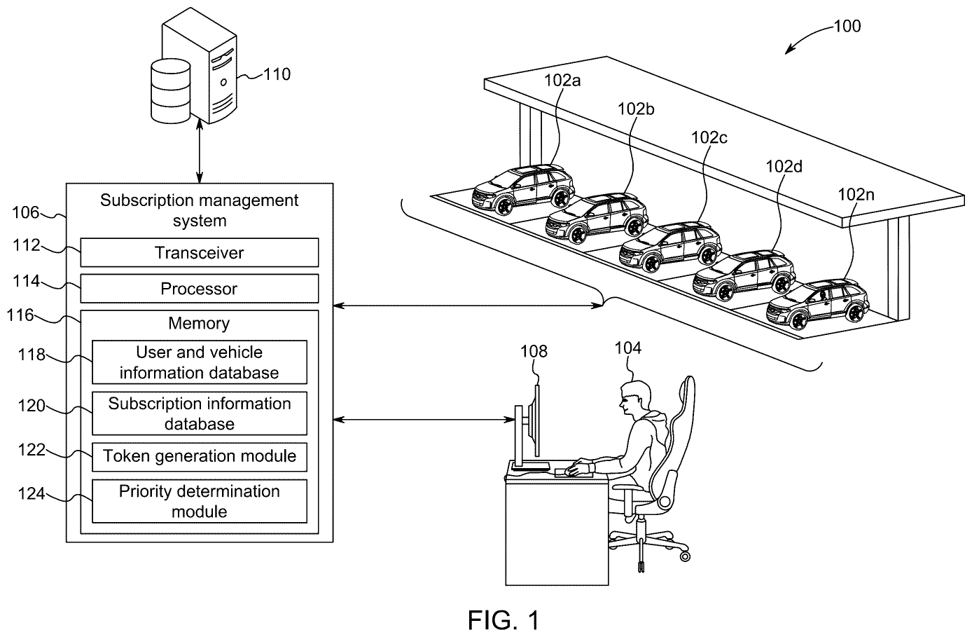

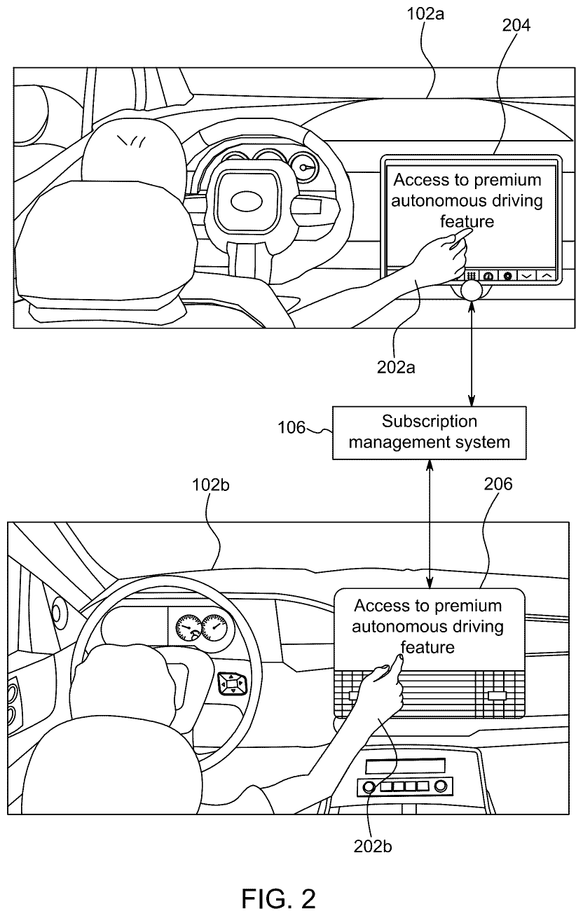

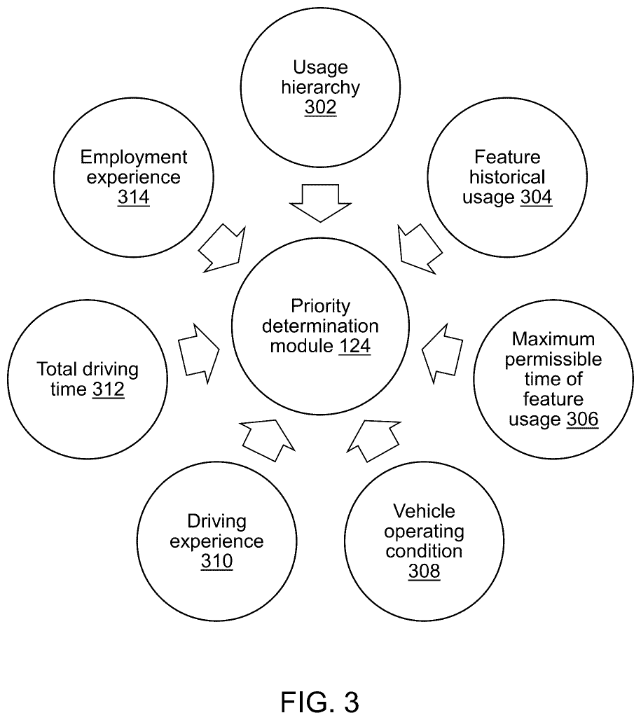

FIG. 1 depicts an environment 100 in which techniques and structures for providing the systems and methods disclosed herein may be implemented. FIG. 1 will be described in conjunction with FIGS. 2 and 3.

The environment 100 may include a plurality of vehicles 102a, 102b, 102c, 102d, 102n (collectively referred to as vehicles 102) that may be part of a vehicle fleet. In an exemplary aspect, the vehicle fleet may be managed by a fleet manager 104. Each vehicle 102 may be driven by or associated with a driver and/or an occupant. For example, the vehicle 102a may be associated with a driver/occupant/user 202a (shown in FIG. 2), the vehicle 102b may be associated with a driver/occupant/user 202b, and/or the like. Although the present disclosure describes an aspect where the vehicles 102 are part of a vehicle fleet that is managed by the fleet manager 104, and the vehicles 102 are associated with the drivers/users 202a, 202b, etc., such description should not be construed as limiting. In other aspects, the fleet manager 104 may be a vehicle owner (e.g., an owner of the vehicle 102a) and the users 202a, 202b may be family members/friends/acquaintances of the vehicle owner. Consequently, although the present disclosure is described in the context of a vehicle fleet and a fleet manager, such description should not be construed as limiting the applicability of the present disclosure to only vehicle fleets. Throughout the description, the term “fleet manager” can be replaced by “vehicle owner,” and the users 202a, 202b can be replaced with the vehicle owner's family members, friends, etc., without departing from the present disclosure's scope.

Each vehicle 102 may take the form of any passenger or commercial vehicle such as a car, a work vehicle, a crossover vehicle, a truck, a van, a minivan, a taxi, a bus, etc. Further, each vehicle 102 may be a manually driven vehicle or may be configured to operate in a partially/fully autonomous mode. Furthermore, each vehicle 102 may include any powertrain, such as a gasoline engine or a hybrid system.

In some aspects, the fleet manager 104 may have purchased subscription to one or more “premium” vehicle features (or “subscription based vehicle features”) that may be enabled or made accessible in the vehicles 102. Examples of such premium features include, but are not limited to, an autonomous or automated driving feature, a heated sitting area feature, a massaging sitting area feature, a heated steering wheel feature, an entertainment feature, a social networking feature, enhanced vehicle aerodynamic properties, a premium fuel calibration, an enhanced transmission calibration, an enhanced vehicle stability control, a vehicle drift mode, and/or the like. These premium vehicle features may be made accessible in a vehicle only if the vehicle owner or the fleet manager purchases the subscription to these features (e.g., from the vehicle dealership), and not otherwise. Stated another way, the user 202a may not be able to access a premium vehicle feature in the vehicle 102a unless the fleet manager 104 (or the user 202a) purchases the subscription to the premium vehicle feature and the user 202a is an “authorized” user who can use the feature in the vehicle 102a. In some aspects, the vehicle 102a may authorize or authenticate the user 202a (e.g., for enabling the user 202a to use the subscription based vehicle feature) by using known authorization techniques including, but not limited to, facial recognition, fingerprint recognition, password/passcode entry, authentication of a user device associated with the user 202a, an authorized USB dongle usage, and/or the like.

In accordance with the present disclosure, to enable access of the premium vehicle features in the vehicles 102, the fleet manager 104 may not be required to purchase multiple subscriptions equivalent to the count of vehicles 102, but may instead purchase a lesser number of subscriptions and may “share” the subscriptions between the vehicles 102 and/or their associated users. For example, if the fleet manager 104 has five vehicles and desires to purchase a subscription of an autonomous driving feature, the fleet manager 104 may not be required to purchase five subscriptions for the autonomous driving feature, but may instead purchase just two or three subscriptions and may share the purchased subscriptions between the users associated with the vehicles 102. In accordance with the present disclosure, the subscriptions for the premium vehicle features are “portable” amongst a plurality of vehicles and the subscriptions can be “lent” by the fleet manager 104 to the vehicles 102 and/or their associated users based on requirements and for a predetermined (and short) time duration.

In some aspects, the environment 100 may further include a subscription management system 106 (or system 106) that may be communicatively coupled with the vehicles 102, a user device 108 associated with the fleet manager 104, one or more servers 110, and/or the like, via one or more networks. The user device 108 may be, for example, a computer, a laptop, a mobile phone, a tablet, a smartwatch, or any other device with communication capabilities. The network(s), as described herein, illustrates an example communication infrastructure in which the connected devices discussed in various embodiments of this disclosure may communicate. The network(s) may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The system 106 may be hosted on a server or a distributed computing system. The system 106 may facilitate the fleet manager 104 to optimally share the subscriptions described above amongst the users of the vehicles 102, so that the users who require the premium vehicle features the most get to use the features. Stated another way, the system 106 may ensure that “high priority” users get to use the subscribed vehicle features in their vehicles, and the subscribed vehicle features are not unnecessarily used for a long time duration by those users who may be lower in the priority list.

In some aspects, to enable efficient subscription distribution amongst the users, the fleet manager 104 may define or communicate (via the user device 108) to the system 106 which subscriptions can be made shareable with which users/vehicles, if the fleet manger 104 has purchased subscriptions for multiple premium vehicle features. For example, the fleet manager 104 may communicate to the system 106 (via the user device 108) that the subscription for the autonomous driving feature may be made shareable with the users associated with the vehicles 102. The fleet manager 104 may further define or communicate (via the user device 108) to the system 106 the count of “subscribed accounts” (or subscribed users or logins) that the fleet manager 104 has purchased. For example, the fleet manager 104 may communicate to the system 106 that the fleet manager 104 has purchased three accounts or logins for the autonomous driving feature, which can be shared amongst the users associated with the vehicles 102. In other aspects, the system 106 may already have the information associated with the count of subscribed accounts that the fleet manager 104 has purchased (e.g., the system 106 may obtain such information from the server 110), and the fleet manager 104 may not be required to communicate this information to the system 106.

Responsive to receiving such communication/information associated with the subscribed premium vehicle feature from the fleet manager 104 (or from the server 110), the system 106 may optimally share the three accounts/logins owned by the fleet manager 104 amongst the five users associated with the vehicles 102 so that the “high priority” users get to use the premium vehicle feature. Details of the system 106 components and the overall system functioning are described below.

The system 106 may include a plurality of components including, but not limited to, a transceiver 112, a processor 114 and a memory 116. The transceiver 112 may receive information/inputs from one or more external devices or systems, e.g., the user device 108, the server 110, the vehicles 102, user devices associated with the users 202a, 202b, and/or the like via the network described above. Further, the transceiver 112 may transmit notifications to the external devices or systems.

The processor 114 may be in communication with one or more memory devices in communication with the respective computing systems (e.g., the memory 116 and/or one or more external databases not shown in FIG. 1). The processor 114 may utilize the memory 116 to store programs in code and/or to store data for performing aspects in accordance with the disclosure. The memory 116 may be a non-transitory computer-readable medium or memory storing a subscription management program code. The memory 116 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the memory 116 may include a plurality of databases and modules including, but not limited to, a user and vehicle information database 118, a subscription information database 120, a token generation module 122, a priority determination module 124, and/or the like. The token generation module 122 and the priority determination module 124 may be stored as computer executable instructions in the memory 116, and the processor 114 may execute these instructions to perform one or more operations in accordance with the present disclosure. The functions of these modules are described later in the description below.

The user and vehicle information database 118 may store information associated with each user and each vehicle 102. For example, the user and vehicle information database 118 may store information associated with the vehicles 102 and the users 202a, 202b (and remaining users associated with the vehicles 102). Examples of information stored in the user and vehicle information database 118 include, but are not limited to, historical usage of subscription based vehicle features by each user, operational conditions of each vehicle 102 (e.g., whether the vehicle 102 is connected to a trailer, the vehicle's SOC level, etc.), total driving experience (in months or years) of each user, a total driving time for each user over a predefined time duration (e.g., in a day), an employment experience of each user with the vehicle fleet's firm, and/or the like. In an exemplary aspect, the system 106 may receive some or all of this information from the server 110, the vehicles 102, the user devices associated with the users of the vehicles 102, and/or the user device 108 associated with the fleet manager 104.

The subscription information database 120 may store subscription information associated with the subscriptions for the premium vehicle features purchased or owned by the fleet manager 104. Examples of such subscription information include, but are not limited to, information associated with which subscriptions can be made shareable with which users/vehicles, the count of subscribed accounts (or subscribed users or logins) for each feature purchased by the fleet manager 104, a subscription policy defined by the fleet manager 104 indicating how the fleet manager 104 desires the subscriptions to be distributed amongst the vehicle users, and/or the like. In an exemplary aspect, the system 106 may receive some or all of this subscription information from the server 110 and/or the user device 108 associated with the fleet manager 104.

In operation, the fleet manager 104 may share (via the user device 108) the subscription information described above to the transceiver 112 when the fleet manager 104 desires to optimally distribute the subscriptions owned by the fleet manager 104 amongst the vehicle fleet users/drivers. As described above, in the subscription information, the fleet manager 104 may define which subscriptions can be made shareable with which users/vehicles. For example, the fleet manager 104 may define that the subscription for the autonomous driving feature may be distributed amongst the users of the vehicles 102 (including the users 202a, 202b). The fleet manager 104 may further communicate (as part of the subscription information) to the transceiver 112 a count of subscription accounts or logins for the autonomous driving feature that the fleet manager 104 owns. For example, the fleet manager 104 may communicate that the fleet manager 104 owns three logins, which can be shared with the users associated with the vehicle 102. The fleet manager 104 may further define (as part of the subscription information) a subscription policy (or a “multi-token subscription policy”) indicating a preferred manner in which the fleet manager 104 may desire the subscription logins to be distributed.

The transceiver 112 may transmit the subscription information described above to the processor 114 and the subscription information database 120 for storage. Responsive to obtaining the subscription information, the processor 114 may first create a “sharing network” including the users associated with the vehicles 102 (who may request for the premium feature of autonomous driving feature). The processor 114 may further execute the instructions stored in the token generation module 122 to generate a plurality of tokens associated with the subscription based vehicle feature (i.e., the premium feature of autonomous driving feature) based on the subscription policy defined by the fleet manager 104 (or the subscription owner). As described above, the subscription policy may be part of the subscription information provided by the fleet manager 104 to the system 106. A brief description of a “token” is provided below.

A token associated with a subscription based vehicle feature may be an authentication or authorization means by which a vehicle may enable the vehicle feature in the vehicle. Specifically, when the system 106 desires to make the subscription based vehicle feature enabled in a vehicle, the system 106 may transmit the token to the vehicle. Responsive to receiving the token, the vehicle can change the operational state of the subscription based vehicle feature in the vehicle from an inaccessible state to an accessible state. In this manner, the token acts as an authentication or authorization means by which a vehicle may enable a premium vehicle feature in the vehicle. The premium vehicle feature cannot be made accessible in a vehicle unless the vehicle possesses the token. In some aspects, the token includes login credentials for the subscription (or the subscription based vehicle feature), which automatically gets entered into the application (“app”) associated with the vehicle feature installed in the vehicle, thereby enabling the vehicle to make the premium feature accessible. Furthermore, a token can enable the subscription based premium vehicle feature at a single vehicle in a given time. Stated another way, the same token cannot be used concurrently on more than one vehicle. If two or more vehicles desire to enable the premium vehicle feature (e.g., the autonomous driving feature), each vehicle must have its own unique token. Further, some tokens can be used on specific features and not on others. For example, an entertainment token can only be used on entertainment features and not on cruise control features.

Responsive to generating the plurality of tokens associated with the subscription based vehicle feature (i.e., the premium feature of autonomous driving feature) based on the subscription policy as described above, the processor 114 may make the tokens “available” in the sharing network including the users associated with the vehicles 102. Making the tokens available in the sharing network means that the users of the vehicles 102 may anytime determine how many tokens are unused or available for the users to “claim” or request access to. Once a user determines that a token is available in the sharing network, the user may transmit a request to the system 106 to obtain the token in the user's vehicle, thereby making the premium feature accessible in the vehicle.

It may be appreciated that if the count of tokens that are generated and made available in the sharing network (as per the subscription policy defined by the fleet manager 104) is less than the count of subscription logins/accounts owned by the fleet manager 104, the users may use the token without any conflict. For example, if the count of subscription logins/accounts is three and the processor 114 generates two tokens as per the subscription policy defined by the fleet manager 104, then the two tokens can be easily distributed amongst the users associated with the vehicles 102 without any conflict, as at any time, only two users can request for the tokens and the fleet manager 104 owns three logins/accounts. Stated another way, in this case, there would never be a scenario where the count of concurrent requests for the tokens (and hence the count of requests to access the premium vehicle features) increases the count of logins/accounts owned by the fleet manager 104. The same scenario will be there even if the count of token is equivalent to the count of logins/accounts owned by the fleet manager 104. In these cases, in an exemplary aspect, the processor 114 may also create a separate sharing network for each token.

However, a conflict may occur if the count of tokens that are generated and made available in the sharing network (as per the subscription policy defined by the fleet manager 104) is greater than the count of subscription logins/accounts owned by the fleet manager 104. For example, if the count of subscription logins/accounts is three and the processor 114 generates five tokens as per the subscription policy defined by the fleet manager 104, then a conflict may occur if four or five users concurrently request to obtain the available tokens while the logins/accounts are just three. In this case, the processor 114 may determine a priority list of the users requesting to obtain the tokens and may distribute the tokens as per the priority list. An example method implemented by the processor 114 to optimize token distribution in this case is described below.

Responsive to generating and making available the plurality of tokens in the sharing network as described above, the processor 114 may first determine the count of subscribed or subscription users/logins/accounts associated with the subscription based vehicle feature (e.g., the autonomous driving feature) that the fleet manager 104 owns. The processor 114 may then compare the count of subscription accounts with the count of tokens made available in the sharing network as per the subscription policy defined by the fleet manager 104. The processor 114 may determine a priority of vehicle feature usage between two users (e.g., the users 202a, 202b) requesting access to the subscription based vehicle feature at the same time, responsive to determining that the count of subscribed users/logins/accounts is less than the count of the tokens. The description below describes an exemplary aspect where the users 202a, 202b are requesting access to the subscription based vehicle feature at the same time, while the count of generated tokens is greater than the count of subscription accounts owned by the fleet manager 104 (e.g., when the count of generated tokens is five and the count of subscription accounts owned by the fleet manager 104 is three).

In the example scenario described above, the transceiver 112 may receive a first request from the user 202a to enable the subscription based vehicle feature in the vehicle 102a, and at the same time, receive a second request from the user 202b to enable the subscription based vehicle feature in the vehicle 102b. In some aspects, the transceiver 112 may receive the first request from a first user device associated with the user 202a or a human-machine interface (HMI) 204 associated with the vehicle 102a and may receive the second request from a second user device associated with the user 202b or an HMI 206 (shown in FIG. 2) associated with the vehicle 102b. The transceiver 112 may transmit the first and second requests to the processor 114.

Responsive to obtaining the first and second requests, the processor 114 may obtain first information associated with the user 202a and the vehicle 102a, and second information associated with the user 202b and the vehicle 102b. In some aspects, the processor 114 may obtain the first and second information from the server 110, the vehicles 102a, 102b, and/or the user and vehicle information database 118. The examples of the information associated with the users 202a, 202b and the vehicles 102a, 102b stored in the user and vehicle information database 118 are already described above.

The processor 114 may then execute the instructions stored in the priority determination module 124 to determine a priority of vehicle feature usage between the user 202a and the user 202b based on the obtained first information and the second information. Stated another way, if both the users 202a, 202b request to access the autonomous driving feature in their respective vehicles 102a, 102b at the same time, the processor 114 may determine a priority of usage of the autonomous driving feature between the users 202a, 202b based on the obtained first and second information. The processor 114 may then enable the subscription based vehicle feature or the autonomous driving feature in either the vehicle 102a or the vehicle 102b based on the determined priority.

The processor 114 may determine the priority described above based on a plurality of parameters, as depicted in FIG. 3. For example, the processor 114 may determine the priority based on usage hierarchy 302, vehicle feature historical usage 304, a maximum permissible time of vehicle feature usage 306, the vehicle's operational or operating condition 308, user's driving experience 310, a total driving time 312 for the users, user's employment experience 314, and/or the like. These parameters are described below.

In one exemplary aspect, the processor 114 may determine the priority of vehicle feature usage between the users 202a, 202b based on the usage hierarchy 302 defined by the fleet manager 104 (or the subscription owner). For example, if the usage hierarchy 302 indicates that the user 202a should be given priority whenever the users 202a, 202b request to access the premium vehicle feature, the processor 114 may determine that the priority of vehicle feature usage is higher for the user 202a as compared to the user 202b.

In another exemplary aspect, the processor 114 may determine the priority of vehicle feature usage between the users 202a, 202b based on the historical usage 304 of the subscription based vehicle feature (e.g., the autonomous driving feature) by the users 202a, 202b. For example, the priority of vehicle feature usage is higher for the user 202a when the historical usage of the subscription based vehicle feature by the user 202a is lower than the historical usage of the subscription based vehicle feature by the user 202b. Stated another way, the vehicle operator/user who may have been using the vehicle feature the longest will have the lowest priority. In some aspects, the information associated with the historical usage 304 of the subscription based vehicle feature by the users 202a, 202b is part of the first and second information that is obtained by the processor 114, as described above.

In yet another exemplary aspect, the processor 114 may determine the priority of vehicle feature usage between the users 202a, 202b based on the maximum permissible time (e.g., 2 hours or 3 hours) of vehicle feature usage 306 over a predefined time duration (e.g., over a day), as defined by the fleet manager 104 (or the subscription owner). For example, the priority of vehicle feature usage may be higher for the user 202a when the user 202b has used the subscription based vehicle feature for a time greater than the maximum permissible time of feature usage over the predefined time duration/one day.

In yet another exemplary aspect, the processor 114 may determine the operational or operating conditions 308 of the vehicles 102a. 102b based on the first information and the second information and determine the priority of vehicle feature usage between the users 202a, 202b based on the determined operational conditions. For example, if the operational conditions 308 indicate that the vehicle 102a is connected to a trailer and the user 202a desires to use the autonomous self-driving feature, the user 202a may be given a higher priority over the user 202b.

In yet another exemplary aspect, the processor 114 may determine the priority of vehicle feature usage between the users 202a, 202b based on the driving experience 310 of each user 202a, 202b. As may be appreciated, new drivers may need more assistance and may need use of various automated driving features to ensure that they can drive in certain locations, such as highways. In this case, if the user 202a has less driving experience than the user 202b, the processor 114 may give a higher priority to the user 202a. In some aspects, the information associated with the driving experience 310 of each user 202a, 202b is part of the first and second information that is obtained by the processor 114, as described above.

In yet another exemplary aspect, the processor 114 may determine the priority of vehicle feature usage between the users 202a, 202b based on the total driving time 312 in a predefined time duration (e.g., in a day) associated with each user 202a, 202b. For example, if the user 202a has been driving the vehicle 102a for a longer time duration as compared to the user 202b, the user 202a may be given a higher priority as the user 202a may require more premium vehicle features to aid/help the user 202a stay engaged while driving. In some aspects, the information associated with the total driving time 312 of each user 202a, 202b is part of the first and second information that is obtained by the processor 114, as described above.

In yet another exemplary aspect, the processor 114 may determine the priority of vehicle feature usage between the users 202a, 202b based on the employment experience 314 of each user 202a, 202b. For example, if the user 202a has been working with the fleet manager 104 for a longer time duration than the user 202b, the user 202a may be given a higher priority (or vice-versa). In some aspects, the information associated with the employment experience 314 of each user 202a, 202b is part of the first and second information that is obtained by the processor 114, as described above.

Responsive to determining the priority of vehicle feature usage between the users 202a, 202b by using any of the parameters described above, the processor 114 may enable the subscription based premium vehicle feature in the vehicle associated with the user having the higher priority. For example, if the user 202a has a higher priority as compared to the user 202b, the processor 114 may enable the subscription based premium vehicle feature (e.g., the autonomous driving feature) in the vehicle 102a. In some aspects, the processor 114 may enable the premium vehicle feature in the vehicle 102a by transmitting a token (from the plurality of tokens generated by the processor 114) to the vehicle 102a. The vehicle 102a may enable the premium vehicle feature or change the state of the premium vehicle feature from an inaccessible state to an accessible state responsive to receiving the token from the system 106/processor 114. In some aspects, if the count of available tokens exceeds the number of concurrent users due to a user no longer using the feature (e.g., if the user 202a is no longer using the premium vehicle feature), the processor 114 may reassign the token back to the operator/user (e.g., the user 202b) who lost possession of it.

The system 106 may provide one or more additional features to the vehicle 102a/user 202a to enable efficient operation of the premium vehicle feature in the vehicle 102a. For example, if the vehicle 102a determines that it does not have the application (“app”) associated with the premium vehicle feature, the vehicle 102a may transmit a download request to the system 106. The processor 114 may obtain the download request from the vehicle 102a to install the application associated with the subscription based vehicle feature, when the vehicle 102a does not have the application pre-installed. Responsive to obtaining the download request, the processor 114 may fetch the application files associated with the subscription based vehicle feature from the memory 116 or the server 110 and transmit the application files to the vehicle 102a. The vehicle 102a may then install the application by executing the received application files. The vehicle 102a may further automatically enter the login credentials (which may be part of the token obtained from the system 106) for the subscription in the application, to enable the user 202a to conveniently operate the premium feature in the vehicle 102a.

The system 106 and the vehicles 102 implement and/or perform operations, as described here in the present disclosure, in accordance with the owner manual and safety guidelines. In addition, any action taken by the users 202a, 202b based on the notifications provided by the vehicles 102 or the system 106, should comply with all the rules specific to the location and operation of the vehicles 102 (e.g., Federal, state, country, city, etc.). The notifications, as provided by the vehicles 102 or the system 106, should be treated as suggestions and only followed according to any rules specific to the location and operation of the vehicles 102.

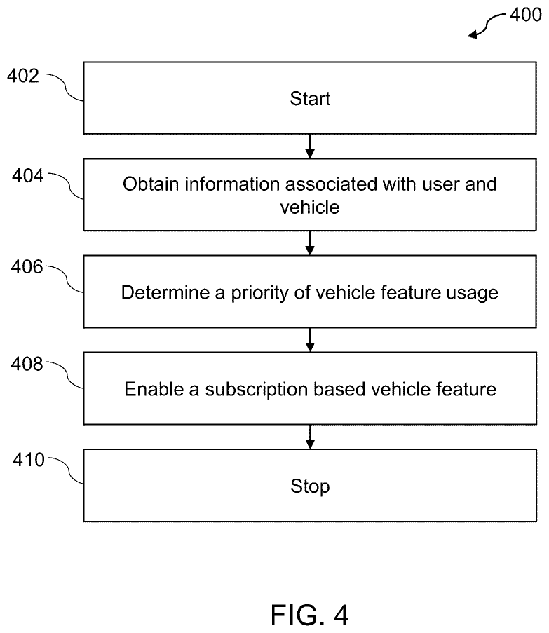

FIG. 4 depicts a flow diagram of an example method 400 to enable prioritization of vehicle feature subscription sharing in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include obtaining, by the processor 114, the first information and the second information associated with the users 202a, 202b and the vehicles 102a, 102b, as described above. At step 406, the method 400 may include determining, by the processor 114, the priority of vehicle feature usage between the users 202a, 202b based on the first information and the second information. At step 408, the method 400 may include enabling, by the processor 114, the subscription based vehicle feature in either the vehicle 102a or the vehicle 102b based on the priority.

At step 410, the method 400 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a transceiver configured to:
receive a first request from a first user associated with a first vehicle to enable a subscription based vehicle feature in the first vehicle; and
receive a second request from a second user associated with a second vehicle to enable the subscription based vehicle feature in the second vehicle; and
a processor configured to:
obtain a first information associated with the first user and the first vehicle, and a second information associated with the second user and the second vehicle, responsive to obtaining the first request and the second request;
determine a priority of vehicle feature usage between the first user and the second user based on the first information and the second information; and
enable the subscription based vehicle feature in either the first vehicle or the second vehicle based on the priority.

2. The system of claim 1, wherein the subscription based vehicle feature is associated with one or more of: an autonomous driving feature, a heated sitting area feature, a massaging sitting area feature, a heated steering wheel feature, an entertainment feature, a social networking feature, enhanced vehicle aerodynamic properties, a premium fuel calibration, an enhanced transmission calibration, an enhanced vehicle stability control, or a vehicle drift mode.

3. The system of claim 1, wherein the processor is further configured to:
generate a plurality of tokens associated with the subscription based vehicle feature based on a subscription policy defined by a subscription owner or a fleet manager;
determine a count of subscribed users associated with the subscription based vehicle feature;
determine that the count of subscribed users is less than a count of the plurality of tokens; and
determine the priority of vehicle feature usage between the first user and the second user responsive to determining that the count of subscribed users is less than the count of the plurality of tokens.

4. The system of claim 3, wherein the processor is further configured to transmit a token, from the plurality of tokens, to either the first vehicle or the second vehicle based on the priority, and wherein the first vehicle or the second vehicle is configured to enable the subscription based vehicle feature responsive to receiving the token.

5. The system of claim 4, wherein the token is configured to enable the subscription based vehicle feature at a single vehicle in a given time.

6. The system of claim 4, wherein the token comprises login credentials associated with the subscription based vehicle feature.

7. The system of claim 1, wherein the processor determines the priority of vehicle feature usage based on a usage hierarchy defined by a subscription owner or a fleet manager.

8. The system of claim 1, wherein the processor determines the priority of vehicle feature usage based on a historical usage of the subscription based vehicle feature by each of the first user and the second user, and wherein information associated with the historical usage is part of the first information and the second information.

9. The system of claim 8, wherein the priority of vehicle feature usage is higher for the first user when the historical usage of the subscription based vehicle feature by the first user is lower than the historical usage of the subscription based vehicle feature by the second user.

10. The system of claim 1, wherein the processor determines the priority of vehicle feature usage based on a maximum permissible time of feature usage in a predefined time duration defined by a subscription owner or a fleet manager.

11. The system of claim 10, wherein the priority of vehicle feature usage is higher for the first user when the second user has used the subscription based vehicle feature for a time greater than the maximum permissible time of feature usage in the predefined time duration.

12. The system of claim 1, wherein the processor is further configured to:
determine operational conditions of the first vehicle and the second vehicle based on the first information and the second information; and
determine the priority of vehicle feature usage based on the operational conditions of the first vehicle and the second vehicle.

13. The system of claim 1, wherein the processor determines the priority of vehicle feature usage based on a driving experience of each of the first user and the second user, and wherein information associated with the driving experience is part of the first information and the second information.

14. The system of claim 1, wherein the processor determines the priority of vehicle feature usage based on a total driving time in a predefined time duration associated with each of the first user and the second user, and wherein information associated with the total driving time is part of the first information and the second information.

15. The system of claim 1, wherein the processor determines the priority of vehicle feature usage based on an employment experience of each of the first user and the second user, and wherein information associated with the employment experience is part of the first information and the second information.

16. The system of claim 1, wherein the transceiver receives the first request from a first user device or a human-machine interface (HMI) associated with the first vehicle, and wherein the transceiver receives the second request from a second user device or an HMI associated with the second vehicle.

17. The system of claim 1, wherein the processor obtains the first information from the first vehicle or a server, and wherein the processor obtains the second information from the second vehicle or the server.

18. The system of claim 1, wherein the processor is further configured to:
obtain a download request from the first vehicle or the second vehicle to install an application associated with the subscription based vehicle feature when the first vehicle or the second vehicle does not have the application pre-installed; and
transmit application files associated with the subscription based vehicle feature to the first vehicle or the second vehicle responsive to obtaining the download request.

19. A method comprising:
obtaining, by a processor, a first information associated with a first user and a first vehicle, and a second information associated with a second user and a second vehicle, responsive to obtaining a first request and a second request, wherein:
the first request is obtained from the first user associated with the first vehicle to enable a subscription based vehicle feature in the first vehicle, and
the second request is obtained from the second user associated with the second vehicle to enable the subscription based vehicle feature in the second vehicle;
determining, by the processor, a priority of vehicle feature usage between the first user and the second user based on the first information and the second information; and
enabling, by the processor, the subscription based vehicle feature in either the first vehicle or the second vehicle based on the priority.

20. A non-transitory computer-readable storage medium having instructions stored thereupon which, when executed by a processor, cause the processor to:
obtain a first information associated with a first user and a first vehicle, and a second information associated with a second user and a second vehicle, responsive to obtaining a first request and a second request, wherein:
the first request is obtained from the first user associated with the first vehicle to enable a subscription based vehicle feature in the first vehicle, and
the second request is obtained from the second user associated with the second vehicle to enable the subscription based vehicle feature in the second vehicle;
determine a priority of vehicle feature usage between the first user and the second user based on the first information and the second information; and
enable the subscription based vehicle feature in either the first vehicle or the second vehicle based on the priority.
